(19) United States
(12) Patent Application Publication
(10) Pub. No.: US 2020/0326697 A1
(43) Pub. Date: Oct. 15, 2020

(54) SYSTEM TO DYNAMICALLY ADJUST SAMPLING AND COMMUNICATION FREQUENCY OF A WIRELESS MACHINE CONDITION MONITORING NETWORK

(71) Applicant: Nikola Labs, Westerville, OH (US)

(72) Inventors: Ryan Somogye, Grove City, OH (US); Jonathan Eric Turner, Lewis Center, OH (US); James Dvorsky, Plain City, OH (US)

(73) Assignee: Nikola Labs, Westerville, OH (US)

(21) Appl. No.: 16/384,516

(22) Filed: Apr. 15, 2019

(51) Int. Cl. G05B 23/02; H04L 29/08; G06Q 10/00

(52) U.S. Cl. CPC G05B 23/0283; G06Q 10/20; H04L 67/12

(57) ABSTRACT

A system includes a wireless receiver and sensor module and a transponder. The wireless receiver and sensor module monitors a condition of a machine, and generate data that quantifies a machine condition. The transponder connects with the wireless receiver and sensor module to receive the data from the wireless receiver and sensor module. The transponder determines a sampling frequency for the wireless receiver and sensor module based on the machine condition.

### CROSS REFERENCE TO RELATED APPLICATIONS

This application incorporates by reference in its entirety commonly owned U.S. Non-Provisional Patent Application entitled “SYSTEM AND METHODS FOR MACHINE CONDITION MONITORING,” (ATTY DOCKET NO. 46659-40), filed the same day herewith.

### TECHNICAL FIELD

The disclosure relates to a system that dynamically adjusts the data sampling frequency and the data transmission frequency of a distributed array of wireless sensors as a function of the sensor's available stored energy and the condition, or quality, of the collected data.

### BACKGROUND

A system to monitor the condition of machinery can take the form of an array of wireless sensors distributed on or near the machinery with a transponder mounted in relative proximity to all of the sensors. The transponder broadcasts radio frequency (RF) power that is harvested by the sensors, converted into useful DC electricity, and accumulated in a non-serviceable electrical storage element. The transponder can communicate bi-directionally with each sensor to receive the collected sensor data and transmit configuration information to set the unique behavior of each sensor.

### SUMMARY

In one example, a system includes a wireless receiver and sensor module and a transponder. The wireless receiver and sensor module monitors a condition of a machine, and generate data that quantifies a machine condition. The transponder connects with the wireless receiver and sensor module to receive the data from the wireless receiver and sensor module. The transponder determines a sampling frequency for the wireless receiver and sensor module based on the machine condition.

In another example, a data collection and data transmission scheduling system can be implemented on a transponder and an array of wireless receiver and sensor modules (RSM). The system can provide that the RSMs schedule their data collection and data transmission activities to stay within an electrical power budget. The power budget for any given RSM is unique and can be driven by 1) the RSM distance from the transponder, e.g., the amount of RF power it receives, 2) the nature of the data being sampled and the inherent power and on-time requirements of the sensor type, and 3) changes in sampling frequency as a result of overall system analysis of the machinery condition. RSMs do not directly influence the power budget of other RSMs since each receives a portion of the RF power broadcast by the transponder. However, data collected by any RSM in the array can indirectly influence another RSM's data collection and transmission schedule as the overall system is able to reconfigure the data collection priorities to adapt to varying machinery condition.

In another example, a method includes receiving data from a wireless receiver and sensor module, where the data quantifies a machine condition of a machine, and determining a sampling frequency for the wireless receiver and sensor module based on the machine condition.

The summary is provided merely for purposes of summarizing some example embodiments so as to provide a basic understanding of some aspects of the disclosure. Accordingly, it will be appreciated that the above described examples should not be construed to narrow the scope or spirit of the disclosure in any way. Other examples, embodiments, aspects, and advantages will become apparent from the following detailed description taken in conjunction with the accompanying drawings.

### BRIEF DESCRIPTION OF THE DRAWINGS

The accompanying figures, which are incorporated in and constitute a part of the specification, illustrate various example systems, apparatuses, and methods, and are used merely to illustrate various example embodiments. In the figures, like elements bear like reference numerals.

FIG. 1 illustrates an exemplary industrial wireless sensor network system.

FIG. 2 is an example graphical representation of the decrease of machine condition over time including some example detectable condition indicators and the approximate time of occurrence.

FIG. 3 is a graphical representation of an example relative importance of measuring various condition indicators as the deterioration of machine condition progresses.

FIG. 4 is an example graphical representation of the various distances between the transponder and each receiver and sensor module (RSM) in an example installation.

FIG. 5 illustrates the two types of example data flow cycles that occur in the RSM.

FIG. 6 illustrates an example data flow cycle that occurs in the transponder for the RSM.

FIG. 7 illustrates an example high-level determination of sampling frequencies for each individual sensor within an RSM and the limits placed on the TX/RX cycle for that RSM.

FIG. 8 is a block diagram of an example processing system.

### DETAILED DESCRIPTION

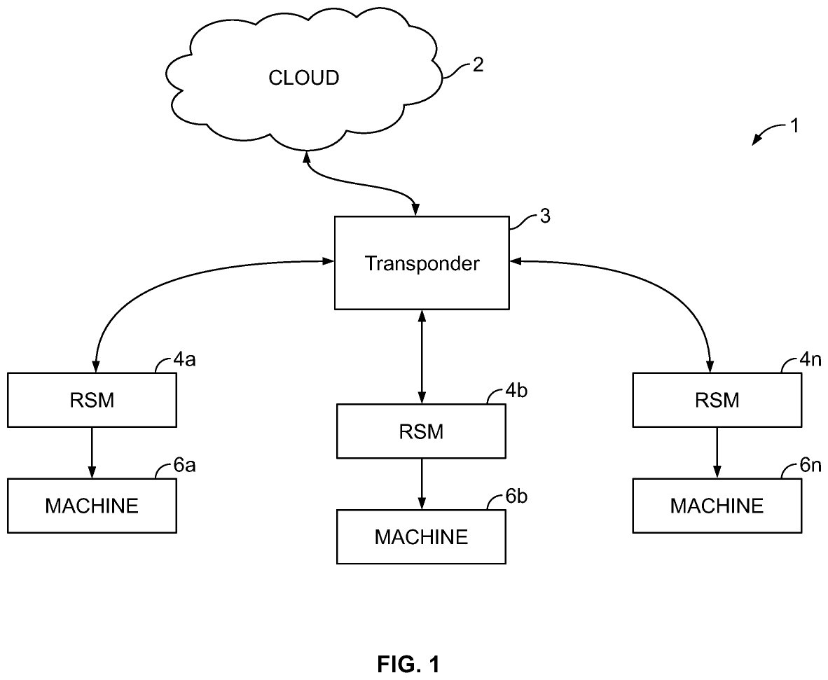

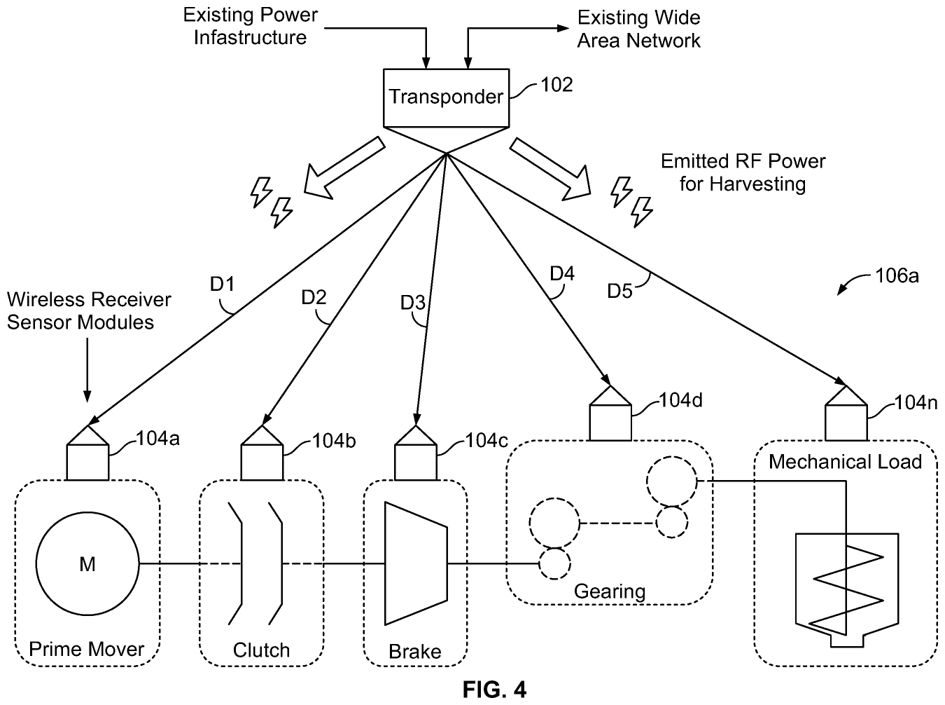

FIG. 1 illustrates an exemplary industrial wireless sensor network system 1. In some examples, the wireless sensor network system 1 can include receiver and sensor modules (RSMs) 4a-n connected with machinery 6a-n and a transponder 3. The RSM 4a-n can collect and transmit data to the transponder 3. The receiver and sensor of the RSM 4a-n can be implemented together in the same module and/or in separate modules. The transponder 3 can also connect with a cloud 2, e.g., for processing, data storage, communications, etc. In some examples, more than one RSM 4a-n can be associated with a single machine 6a-n. For example, the RSM's 4a-n can connect with a prime mover, a clutch, a brake, gearing, a mechanical load, etc. of the machine 6a-n (see, e.g., FIG. 4). In some examples, since the energy contained in each RSM 4a-n is finite, the system 1 can limit a frequency that the RSM 4a-n collects and transmits data to the transponder 3. Moreover, in some examples, since the condition of machinery 6a-n being monitored is expected to vary over time, the system 1 can vary the frequency of data collection for each RSM 4a-n to more effectively monitor particular parameters of interest. Further, in some examples, since each RSM 4a-n can be configured with multiple types of sensors, the system 1 can vary the data collection of each type of sensor within the RSM 4a-n over time.

Embodiments are described for a system and/or method, generally referred to as the system 1, that dynamically adjusts the data collection frequency and the data transmission frequency, e.g., to maximize the system's overall ability to monitor a condition of the machinery 6a-n and recognize impending failure as early as possible. The system 1 can include, but is not limited to, hardware, software, software running on hardware, a process implemented in software or hardware, or a combination thereof. In some examples, the system 1 provides the following inputs: 1) the level of harvested energy stored in each RSM 4a-n, 2) the time and energy cost of performing each type of data collection activity, and 3) the condition of the machinery 6a-n being monitored as determined by analysis of the collected data. Any or all combinations of input information, as well as additional input information, may be used. The system 1 can provide the following outputs: 1) a determined data collection delay time for each type of sensor contained inside each individual RSM 4a-n and 2) a determined data transmission delay for each RSM. Any or all combinations of output information, as well as additional output information, may be used.

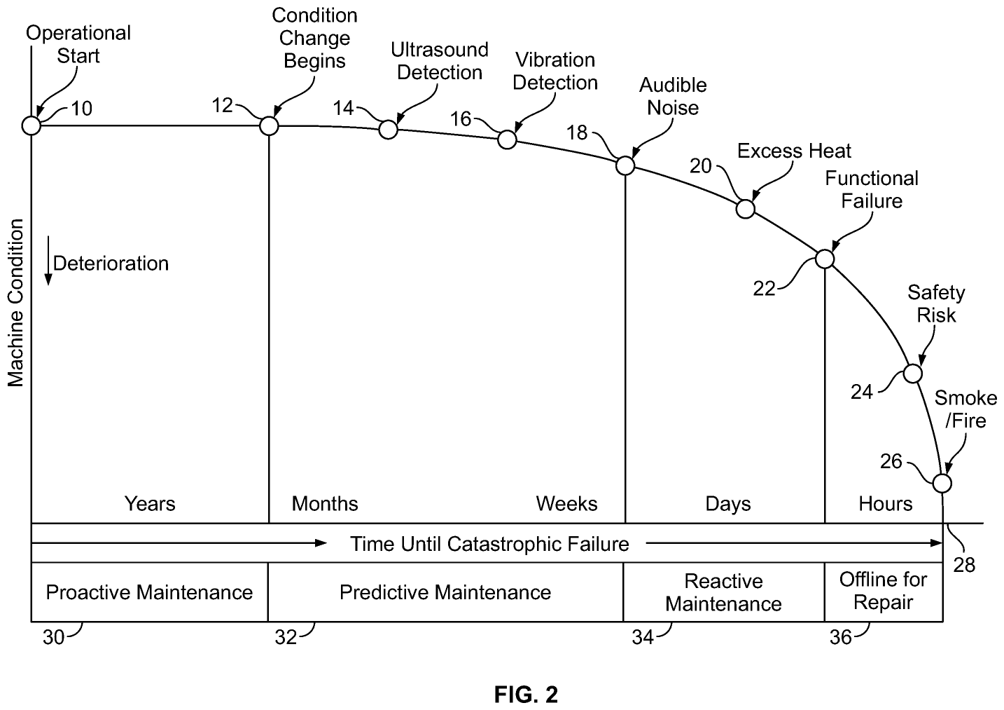

FIG. 2 is an example graphical representation of the decrease of a machine condition of the machinery 6a-n over time including some example detectable condition indicators and the approximate time of occurrence. In FIG. 2, the condition of a machine 6a-n can be plotted as a function of time, from the operational start 10, or commissioning, of the machine 6a-n to the point of catastrophic failure. The time indicated is relative and the actual time until failure, even among similar machines may vary widely. Once the machine's condition change begins 12, it is followed shortly by the first detectable indication of impeding failure, such as ultrasonic detection 14, and then by each successive detectable indication occurs at an accelerated rate. In the example of a bearing failure the sensor detectable indicators of failure include 1) a ultrasonic detection of a change in the machine's noise signature 14, 2) a change in the vibration pattern 16, 3) a change in the audible noise signature 18, 4) a rise of heat production 20, 5) a detection of a function failure 22 (the machinery 6a-n is no longer performing the intended function), 6) detection of an operational safety risk 24 (for example, a loose shaft or failed safety guard), 7) generation of a hazardous machine environment (for example, fire or smoke) 26, and finally catastrophic failure 28.

The time from operational start to catastrophic failure may be divided into various segments 30, 32, 34, 36, e.g., each requiring a different maintenance strategy. The time duration from operational start to the beginning of condition change is a window for proactive maintenance 30. Proactive maintenance 30 may include periodic operational checks and changing/refreshing of the lubricants. Time duration between when the machinery condition change begins and then the first condition indicator is noticeable by human perception, audible noise in this example, is the predictive maintenance interval 32. This predictive maintenance interval 32 may include tracking of the rate of the decreasing condition so physical maintenance may be scheduled and the operational duty cycle of the machine 6a-n may be reduced to prolong life until maintenance may be performed. The time period between the first condition indicator noticeable by human perception and functional failure is the reactive maintenance interval 34. The reactive maintenance interval 34 may include the application of temporary equipment to ensure safe, continuous operation or the deactivation of certain parts of the machinery 6a-n until a repair is available. The time between the function failure and catastrophic failure is the offline repair interval 36 where the machinery 6a-n is taken offline for repair to avoid a catastrophic failure and associated safety concerns.

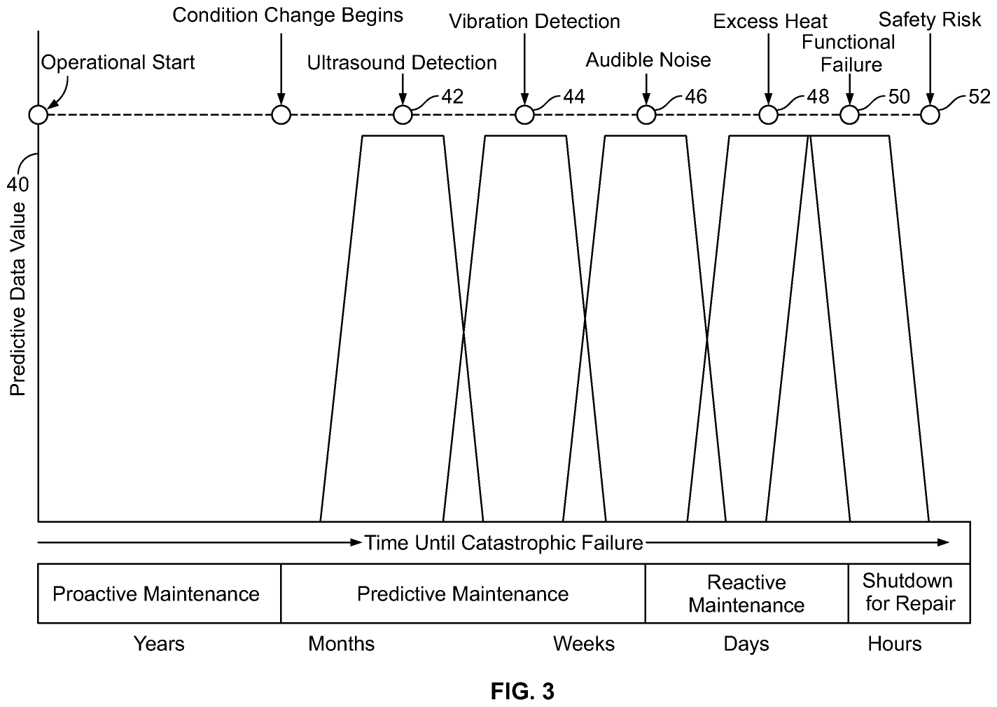

FIG. 3 is a graphical example of the relative importance of different measurement parameters and expected observations as the deterioration of machine condition progresses. In FIG. 3, advantages to more frequently sample a determined type of data for the measurement of a given detectable indicator may be quantified, relative to the other types of indicator data, e.g., using predictive data value functions. Each type of detectable indicator has a unique predictive data value 40 as a function of machine condition (or time until estimated machine failure). More frequent data collection of the condition indicator that is expected to vary may allow for earlier detection of a changing condition.

For example, the system 1 may determine that a change in the ultrasonic signature 42 of the machinery 6a-n occurs before a change in the mechanical vibration 44. Sampling the ultrasonic signature 42 more frequently may allow the detection of the start of condition change earlier than examination of data collected from all other sensors at a uniform rate. Accordingly, once the trend in ultrasonic signature change has been established, an accelerometer measuring the characteristics of vibration can be sampled more frequently instead. Similarly, audible noise 46, excess heat 48, and functional failure 50 detection indicators may have predictive data value functions that overlap and exist in series, respective to the order in which they occur during condition changes. Weighting a sampling frequency of a given sensor at the time when trend identification is important (e.g. when that particular parameter is expected to be the next to change) may allow the actual machine condition to be tracked more accurately, allowing the overall maintenance efforts to be more targeted, timely, and effective.

FIG. 4 is an example graphical representation of the various distances between the transponder 3 and each RSM 4a-n in an example installation. Referring to FIG. 4, one or more RSM 4a-n in a given installation can have a unique distance from the transponder 3, as indicated by distances D1 through D5. Additionally, one or more RSM 4a-n can be uniquely orientated to the transponder's broadcast antenna. Additionally, each specific system installation can have a unique transponder placement and arrangement of the RSM array. Therefore, each RSM 4a-n may receive RF power at a different rate and the sampling frequency of that measurement of interest. Sets of measurements in a priority of interest can be tuned to maximize the sampling and transmission rate while staying within the level of RF power received by a given RSM 4a-n.

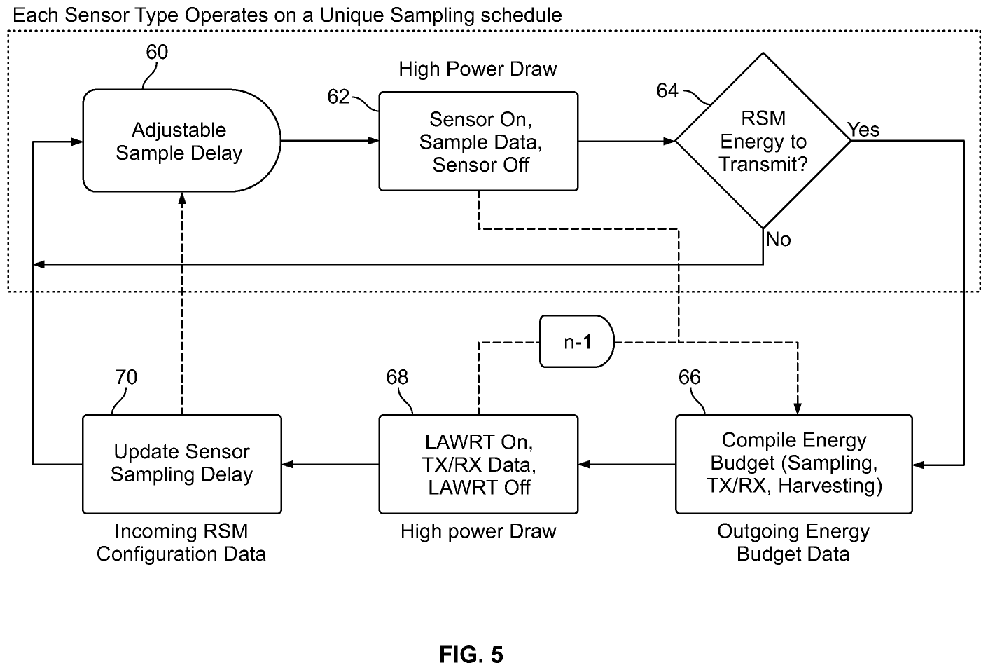

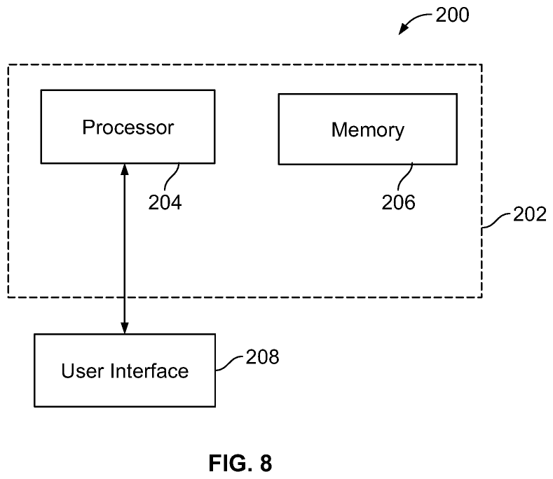

FIG. 5 illustrates the two types of example data flow cycles that occur in the RSM 4a-n: 1) a sensor sample cycle (shown within the dotted area) and 2) a data transmission-receive (TX/RX) cycle (shown outside the dotted area). In some examples, the transponder 3 can determine data TX/RX cycle, e.g., as described in FIG. 8. The sensor sample cycle begins with the expiration of an adjustable sample delay 60. The sensor is powered on, a sample is taken, and the sensor is powered off 62. The activation time of a sensor in the cycle 62 can be short, e.g., about every second down to about every few milliseconds, due to its particularly high-power consumption, especially compared to other sensors associated with RSM. The data in the sensor sample cycle is stored within the RSM 4a-n with each unique type of sensor having an instance of this cycle. Sensor cycles can run simultaneously with the others, as opposed to sequential, but need not sample simultaneously due to the variable sample schedule that is unique to each sensor type. For example, as illustrated in FIG. 3, data associated with one or more sensed parameters may be sampled more frequently than other parameters based on the condition of the machine. That is, the condition of the machine(s) being monitored may determine the RELATIVE frequency of data collection. As a further example, conditions of energy flow and storage within the system 1 may dictate the actual frequency of parameter sampling.

Since the electrical power demand of a TX/RX cycle 68 , e.g., about 45 milliwatts, may be significantly higher than that of a sensor sample cycle, e.g., about 10-15 milliwatts, and TX/RX cycles entail time to establish a connection, time to transmit protocol data (headers, acknowledgements, etc. and time to transmit sensor data, it more energy efficient to accumulate a meaningful amount of sensor data multiple sensor sample cycles and transmit them in one TX/RX cycle. The TX/RX cycle 68 is shown as a process step that may be alternately executed after one or multiple (n) sensor sample cycles. After each completed sample of sensor data, the RSM 4a-n estimates 64 if adequate stored energy is available to complete a TX/RX cycle. The sensor sample cycle 62 restarts if a TX/RX cycle 68 is not initiated. However, if the RSM 4a-n estimates that it does contain enough harvested and stored energy to complete a TX/RX cycle it will proceed to compile the sensor data and calculate energy budget data 66. Energy budget data 66 includes the energy spent sampling each sensor, the energy spent completing the previous TX/RX cycle, and the amount of energy harvested since the last transmission of energy budget data. The RSM 4a-n then powers on the local area wireless radio, transmits the sensor and energy budget data to the transponder 3, and powers down the radio (68). The time the radio is powered on can be minimized by combining several data samples into one message. A purpose of the system 1 is to provide as much information about the machines being monitored as possible. Therefore, the dynamic scheduling algorithm should maximize data flow while balancing the quantity of data against available resources.

Within the same TX/RX cycle 68, the transponder 3 communicates new configuration data to the RSM 4a-n, based on the analysis of the previously communicated energy budget and sampled sensor data. Once the radio is powered off, the RSM 4a-n processes the new configuration data transmitted to it by the transponder 3 to update the sensor sampling delay 70.

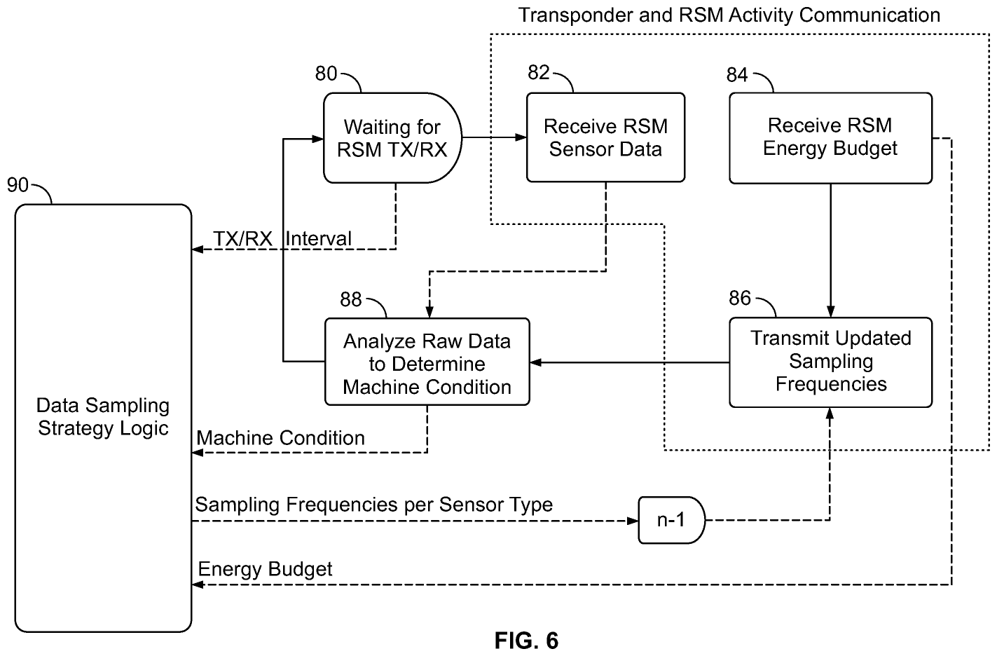

FIG. 6 illustrates an example data flow cycle that occurs in the transponder 3 for the RSM 4a-n. Referring to FIG. 6, each RSM 4a-n communicating with the transponder 3 can have a unique TX/RX cycle initiated by that particular RSM's request to communicate. For the sake of explanation, the cycle is described for a single RSM 4a-n; however, several of these cycles may be implemented in a single transponder 3. For a given RSM 4a-n, the transponder 3 waits for the RSM 4a-n to power-up and request communication 80. The RSM 4a-n spends the majority of its operation in sleep mode, conserving as much energy as possible. Therefore, the RSM 4a-n is not actively listening for messages from the transponder 3.

Sampled sensor data 82 and energy budget information accumulated since the previous TX/RX cycle 84 is received by the transponder 3. The transponder 3 transmits updated sampling frequency configuration data to the RSM 4a-n before the RSM 4a-n powers down the local area wireless transceiver 86. In the Figures, n−1 is a sensor sampling cycle event counter, where n is determined by the amount of energy available versus the energy needed for TX/RX. If n=1, the pathway to TX/RX is taken and the process step is performed. If n>1, the RSM 4a-n goes back to sensor sampling. FIG. 5 shows how the n−1 block influences the process steps. FIG. 6 shows how the n−1 value gets determined and sent to the RSM 4a-n from the transponder 3. The duration that the RSM 4a-n and transponder 3 are in active communication with each other is shown in the doted border. The updated sampling frequency configuration data can be calculated based on the previous cycle's TX/RX interval, machine condition, and energy budget. Performing the calculation of update sampling frequencies real-time during the part of the cycle where the RSM 4a-n local area wireless transceiver is active (indicated by the dotted line) can spend unnecessary RSM energy to keep the communication link active. Once data has been exchanged with the RSM 4a-n and its local area wireless radio has powered down, the sampled raw sensor data is analyzed to estimate machine condition 88 (by the transponder 3 locally or the central storage and processing server, depending on the computing requirements). The data sampling strategy logic 90 then uses the TX/RX interval, estimated machine condition, and energy budget to generate new sampling frequencies to be sent during the next TX/RX cycle.

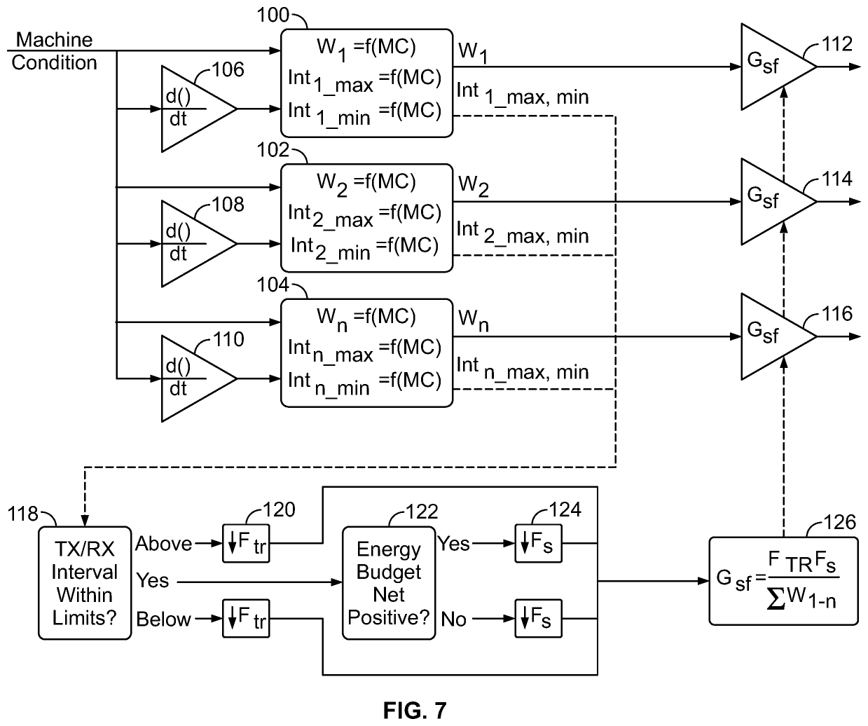

FIG. 7 illustrates an example high-level determination of sampling frequencies for each individual sensor within an RSM 4a-n and the limits placed on the TX/RX cycle for that RSM 4a-n. In FIG. 7, the data sampling strategy logic is implemented with a collection of functions that are evaluated once per completion of every TX/RX cycle. As described in FIG. 6, the machine condition can be calculated based on the total sensor data set from all of the installed RSMs 4a-n. A machine condition of the machine 6a-n can be quantified as a single scalar, such as 0% to 100%, or as multi-dimensional matrix, etc. The quantification can capture for any given machine 6a-n, e.g., system of components, the multiple failure modes. Since machine condition is a function of the data from all the sampled RSMs 4a-n, the data sampling strategy logic cycle for a given RSM 4a-n may be re-evaluated at the conclusion of the TX/RX cycle for any RSM 4A-N.

As machine condition changes the value of a particular type of measurement in estimating machine condition is expected to change. For example, when the machine condition is high (e.g., early in the machine's useful life) ultrasonic signature detection may be more useful than frequent audible noise signature information. This varying level of predictive data value can be quantified by formulae that give a weight to a specific type of measurement as a function of machine condition 100, 102, 104 as well as the rate of change of machine condition 106, 108, 110. The formulae generate a set of weighting factors (W1, W2, . . .Wn) for each type of sensor contained within a given RSM 4A-N. The weighting factors represent the desired relative sampling frequency as compared to other sensors through the entire machine condition monitoring system. However, each RSM 4a-n has a unique power budget independent of other RSMs 4a-n and other sensor types and dependent on the RSM's 4a-n unique placement distance from the transponder 3. Therefore, the sampling frequencies of the sensors within a given RSM 4a-n is adjusted as a set to fit within the given power budget. A sampling frequency gain (Gsf) 112, 114, 116 is applied uniformly to each weighting factor as a way to adjust the overall power consumption within a given RSM 4a-n. The type of sensors with the highest value at a given machine condition (the sensor with the largest weighting factor) remains the sensor that is sampled most frequently within that RSM 4A-N. The sensor with the largest weighting factor may not necessarily be sampled more frequently than another type of sensor with a lower weighting factor within a different RSM 4a-n that has a larger power budget.

Referring also to FIG. 5, the TX/RX cycle consumes energy just as does sampling the data from the internal sensors. The RSM 4a-n waits until enough energy has accumulated to successfully complete a TX/RX cycle before it can initiate. The RSM 4a-n has internal data storage to facilitate the acquisition of multiple samples from many sensors such that the expected TX/RX interval is much longer than the expected sampling interval of any sensor type. There may be practical limits on the TX/RX cycle interval. For example, the highest possible TX/RX cycle frequency is once every time a sensor is sampled. The transponder 3 receives the sensor data as quickly as possible, however, a large portion of the RSM's 4a-n power budget is spent transmitting data over the local area wireless transceiver with the lowest possible data value versus transmission overhead ratio. Further, since machine condition changes occur over time periods at least an order of magnitude longer than reasonable TX/RX cycles, the short duration between sampling and transmitting the data may not be of any value in estimating machine condition.

In an example for the other extreme, the least possible TX/RX cycle frequency waits until the RSM 4a-n internal data storage is full of sampled sensor data, forcing the RSM 4a-n to transmit to the transponder 3. While this maximizes the value of each TX/RX cycle, it forces the system 1 to operate with little to no margin on data storage. In actual implementation, the TX/RX cycle interval is far from these extremes and likely determined by the type of data being sampled and the estimated machine condition, itself. Machine condition may not necessarily decrease in a steady, linear fashion thus requiring the lag in the sampled sensor data to be adjustable to balance the RSM's 4a-n energy use with the ability to estimate machine condition in a timely manner appropriate for the particular stage of maintenance.

Limits on the TX/RX cycle interval to transmit a given type of sensor data can be represented as a function of machine condition 100, 102, 104. The transponder 3 compares 118 the most recent TX/RX interval to the minimum and maximum of these limits and adjusts a transmit/receive factor (Ftr) accordingly 120. If the TX/RX interval is above the maximum limit or below the minimum limit then the Ftr factor is decreased or increased, respectively, and Gsf is recalculated. If the TX/RX cycle is within the all of the minimum and maximum limits Ftr is not adjusted and the cycle proceeds to evaluate the RSM's net energy budget 122. If the energy budget data transmitted by the RSM 4a-n shows a net increase or decrease in stored energy then a sampling factor (Fs) is increased or decreased, respectively 124. Gs is recalculated with the adjusted transmission/receive factor, sampling factor, and individual sensor weighting factors to be communicated to the RSM 4a-n during the next TX/RX cycle 126.

FIG. 8 is a block diagram of an example processing system 200. The systems, methods and technologies described above may be implemented in many different ways in many different combinations of hardware, software, firmware, or any combination thereof. In one example, the systems and methods can be implemented with computing power (servers) 202 either on premise or via hosted cloud 2 (SaaS) environment such as Amazon Web Services (AWS), Microsoft's Azure, Google Cloud or similar service. The servers 202 can include processors 204 and/or memory 206. Data collection, ingestion and storage may utilize product and services such as Hadoop, AWS Simple Storage Service (S3), Azure's Blob Storage, Mongo, data warehouses, such as RedShift, SQL Data Warehouse, SQL databases, NoSQL storage and streaming and pipeline services such as Kinesis or Data Pipeline. The systems and methods can also include one or more methods to display results, and various methods to inputs information, e.g., via a user interface 208. The processing capability of the system may be distributed among multiple system components, such as among multiple servers (clusters), which may be distributed virtually throughout the computing environment. Parameters, databases, and other data structures may be separately stored and managed, may be incorporated into a single memory or database, may be logically and physically organized in many different ways, and may implemented in many ways, including those mentioned above such as SQL databases, NoSQL storage, data lakes, data warehouses, and real-time streams. Programs and processes to execute the system may be parts (e.g., subroutines, microservices, etc.) of a single program, separate programs, distributed processes across several computing environments and implemented in many different ways, such as in a library, such as a shared library, separate executables, separate services, web applications, web processes and may store code and data that performs any of the system processing described above. The systems and methods can be implemented over the cloud 2, e.g., cloud computing technologies that provide processing functionality and/or data storage or on premise using local processing and storage capabilities.

What have been described above are examples. It is, of course, not possible to describe every conceivable combination of elements, components, or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system comprising:
a wireless receiver and sensor module to monitor a condition of a machine, the wireless receiver and sensor module to generate data that quantifies a machine condition based on the monitoring; and
a transponder connected with the wireless receiver, the transponder to receive the data from the wireless receiver and sensor module, where the transponder determines a sampling frequency for the wireless receiver and sensor module based on the machine condition.

2. The system of claim 1, where the wireless receiver and sensor module transmits the data to the transponder during a determined TX/RX interval.

3. The system of claim 2, where the transponder updates the sampling frequency based on the received TX/RX interval.

4. The system of claim 3, where the wireless receiver and sensor module further transmits an energy budget data to the transponder, and the transponder further updates the sampling frequency based on the received energy budget data.

5. The system of claim 4, where the energy budget data includes an energy spent sampling sensors of the wireless receiver and sensor module, an energy spent completing a previous TX/RX interval, and an amount of energy harvested since a last transmission of energy budget data.

6. The system of claim 1, where the transponder analyses the generated data that quantifies the condition of the machine to determine the machine condition.

7. The system of claim 6, where the transponder weights a type of measurement of the wireless receiver and sensor module based on the determined machine condition.

8. The system of claim 7, where the weight is based on a determined rate of change of the machine condition.

9. The system of claim 1, where the sampling frequency includes a data collection delay time for each type of sensor contained inside the wireless receiver and sensor module.

10. The system of claim 1, where the transponder further determines a data transmission interval for the wireless receiver and sensor module based on the machine condition and an energy budget data.

11. A method, comprising:
receiving data from a wireless receiver and sensor module, where the data quantifies a machine condition of a machine; and
determining a sampling frequency for the wireless receiver and sensor module based on the machine condition.

12. The method of claim 11, further comprising receiving a determined TX/RX interval.

13. The method of claim 12, further comprising updating the sampling frequency based on the received TX/RX interval.

14. The method of claim 13, further comprising receiving an energy budget data; and
updating the sampling frequency based on the received energy budget data.

15. The method of claim 14, where the energy budget data includes an energy spent sampling sensors of the wireless receiver and sensor module, an energy spent completing a previous TX/RX interval, and an amount of energy harvested since a last transmission of energy budget data.

16. The method of claim 11, further comprising weighting a type of measurement of the wireless receiver and sensor module based on the machine condition.

17. The method of claim 16, further comprising determining a rate of change of the machine condition.

18. The method of claim 17, where the weight is based on a determined rate of change of the machine condition.

19. The method of claim 11, where the sampling frequency includes a data collection delay time for each type of sensor contained inside the wireless receiver and sensor module.

20. The method of claim 11, further comprising determining a data transmission interval for the wireless receiver and sensor module based on the machine condition and an energy budget data.
